(19) United States
(12) Patent Application Publication
(10) Pub. No.: US 2019/0223485 A1
(43) Pub. Date: Jul. 25, 2019

(54) FOODSTUFF

(71) Applicant: Marlow Foods Limited, Yorkshire (GB)

(72) Inventors: Timothy John Andrew Finnigan, Yorkshire (GB); Muyiwa Adetokunbo Akintoye, Cleveland, Yorkshire (GB); Reza Mousavi, Teeside, Yorkshire (GB)

(21) Appl. No.: 16/313,919

(22) PCT Filed: Jun. 22, 2017
(86) PCT No.: PCT/GB2017/051829

§ 371 Date: Dec. 28, 2018

(30) Foreign Application Priority Data
Jun. 28, 2016 (GB) 1611222.9

(51) Int. Cl. A23L 31/00; A23L 29/256; A23J 3/22

(52) U.S. Cl. CPC A23L 31/00; A23L 29/256; A23J 3/227; A23V 2002/00; A23V 2200/10; A23V 2250/208; A23V 2250/548; A23V 2200/122; A23V 2200/15; A23V 2250/5024

(57) ABSTRACT

A foodstuff comprises filamentous fungus, which is preferably a Fusarium specie, and agar. The foodstuff is preferably a packaged sliced product which also includes one or more flavourants. The foodstuff is preferably suitable for vegans.

This invention relates to a foodstuff and particularly, although not exclusively, relates to a foodstuff which comprises a filamentous fungus. In a preferred embodiment, the foodstuff is a meat substitute. The invention also extends to a process for making the foodstuff and a foodstuff made in the process.

It is known, for example from WO 00/15045 (DSM), WO96/21362 (Zeneca) and WO95/23843 (Zeneca) to use edible filamentous fungi as meat-substitutes, for example in the preparation of burgers and sausages. In such uses, filaments of the fungi are bound together, for example with egg albumin, and are texturised so that the product resembles muscle fibres and therefore has a meat-like appearance and texture. Meat substitutes of the type described have been widely commercially available for many years under the trade mark QUORN.

In some circumstances, it is desirable to reduce or even eliminate the amount of egg albumin used with edible fungus in the manufacture of meat-substitutes for example on cost grounds or to produce a product suitable for vegans.

GB2516491A describes edible formulations which may include reduced levels of egg albumin. To achieve a reduction, the edible formulation incorporates divalent or trivalent cations for example calcium ions. However, it is difficult to eliminate use of egg albumin completely and produce a product suitable for vegans or other individuals for whom egg-based products are unacceptable.

It is an object of the invention to address the above-described problems.

Prior to the invention described herein, Applicant understood that development of texture in its foodstuffs comprising filamentous fungus in the form of mycoprotein (described hereinafter) and egg albumin involved the controlled thermal denaturation of the egg albumin proteins that gave rise to the formation of a continuous albumen gel thereby creating a fibre and gel composite. On subsequent freezing, it was believed that further changes to the mechanical properties of the fibre gel composite gave rise to a meat like texture with desirable organoleptic properties. These changes were thought to result from additional interactions during freezing and subsequent frozen storeage, most notably additional opportunities for cross linking of albumen proteins with the net negative surface charge of the mycoprotein, the strengthening of disulphdryl interchange and the formation of hydrophobic interactions within the protein moieties.

The present invention is based on an insight (which contradicts Applicant's previous understanding) into the functioning of egg albumin in foodstuffs of the type described.

According to a first aspect of the invention, there is provided a foodstuff comprising particles of a filamentous fungus and agar.

Said foodstuff may include less than 5 wt % of agar. It may include at least 0.5 wt % or at least 1 wt % of agar. Said foodstuff may include 1-5 wt %, preferably 2.5 to 5 wt %, more preferably 3 to 4.5 wt %, especially 3 to 4 wt % agar. For the avoidance of doubt, references to amounts of agar herein are on a dry matter basis.

Said foodstuff may include 30 to 95 wt % of added filamentous fungus on a wet matter basis. Said “wet” filamentous fungus is suitably mycoprotein paste referred to hereinafter.

Said foodstuff may include at least 7 wt % of said filamentous fungus on a dry matter basis. Said foodstuff may include at least 11 wt %, preferably at least 15 wt % of said filamentous fungus on a dry matter basis. Said foodstuff may include less than 25 wt %, preferably less than 22 wt % or less than 21 wt % of said filamentous fungus on a dry matter basis.

Said foodstuff may include 7 to 25 wt %, preferably 11 to 22 wt %, more preferably 15 to 21 wt % of said filamentous fungus on a dry matter basis.

In said foodstuff, a ratio (A) defined as the weight of filamentous fungus on a dry matter basis divided by the weight of agar may be at least 1, preferably at least 2, more preferably at least 3, especially at least 4. Ratio (A) may be less than 25, suitably less than 20, preferably less than 15, more preferably less than 10, especially less than 7.

Ratio (A) may be in the range 2 to 20, preferably in the range 3 to 15, more preferably in the range 4 to 10, especially in the range 4 to 7.

Said fungal particles suitably comprise an edible filamentous fungus. Said filamentous fungus preferably comprises fungal mycelia and suitably at least 80 wt %, preferably at least 90 wt %, more preferably at least 95 wt % and, especially, at least 99 wt % of the fungal particles in said foodstuff comprise fungal mycelia. Some filamentous fungi may include both fungal mycelia and fruiting bodies. Said fungal particles preferably comprise a filamentous fungus of a type which does not produce fruiting bodies. Where, however, a filamentous fungus of a type which produces fruiting bodies is used, the fungal particles in said foodstuff suitably include at least 80 wt %, preferably at least 90 wt %, more preferably at least 95 wt % of fungal mycelia. Preferably, said fungal particles comprise substantially only fungal mycelia—that is, said fungal particles in said foodstuff preferably do not include any fruiting bodies.

Preferred fungi for said fungal particles have a cell wall which includes chitin and/or chitosan. Preferred fungi have a cell wall which includes polymeric glucosamine. Preferred fungi have a cell wall which includes β1-3 and 1-6 glucans.

Said fungal particles preferably comprise fungus selected from fungi imperfecti.

Preferably, said fungal particles comprise, and preferably consist essentially of, cells of Fusarium species, especially of Fusarium venenatum A3/5 (formerly classified as Fusarium graminearum) (IMI 145425; ATCC PTA-2684 deposited with the American Type Culture Collection, 10801 University Boulevard, Manassas, Va.) as described for example in WO96/21361 (Zeneca) and WO95/23843 (Zeneca).

Preferably, said fungal particles are non-viable. Preferably, said fungal particles have been treated to lower the level of RNA which they contain. Thus, the level of RNA in the fungal particles used is preferably less than the level in an identical fungus when in a viable state.

The level of RNA in the fungal particles is preferably less than 2 wt % on a dry matter basis.

Fungal particles in said foodstuff may comprise filaments having lengths of less than 1000 μm, preferably less than 800 μm. Said filaments may have a length greater than 100 μm, preferably greater than 200 μm. Preferably, fewer than 5 wt %, preferably substantially no, fungal particles in said foodstuff have lengths of greater than 5000 μm; and preferably fewer than 5 wt %, preferably substantially no, fungal particles have lengths of greater than 2500 μm. Preferably, values for the number average of the lengths of said fungal particles in said foodstuff are also as stated above.

Fungal particles in said foodstuff may comprise filaments having diameters of less than 20 μm, preferably less than 10 μm, more preferably 5 μm or less. Said filaments may have diameters greater than 1 μm, preferably greater than 2 μm. Preferably, values for the number average of said diameters of said fungal particles in said foodstuff are also as stated above.

Fungal particles in said foodstuff may comprise filaments having an aspect ratio (length/diameter) of less than 1000, preferably less than 750, more preferably less than 500, especially of 250 or less. The aspect ratio may be greater than 10, preferably greater than 40, more preferably greater than 70. Preferably, values for the average aspect ratio of said fungal particles (i.e. the average of the lengths of the particles divided by the average of the diameters of the fungal particles) in said foodstuff are also as stated above.

The total amount of water in said foodstuff may be at least 25 wt %, preferably at least 30 wt %, more preferably at least 50 wt %, especially at least 70 wt %. The total amount of water may be less than 81 wt %.

The total amount of water in said foodstuff may be in the range 25 to 81 wt %, preferably in the range 50 to 81 wt %, more preferably in the range 60 to 80 wt %.

Said foodstuff may include:

7 to 25 wt % of said filamentous fungus on a dry matter basis;

1 to 5 wt % of agar; and

30 to 85 wt % of water.

Preferably, said foodstuff includes:

15 to 24 wt % of said filamentous fungus on a dry matter basis;

2 to 5 wt % of agar; and

60 to 80 wt % of water.

In said foodstuff, a ratio (B) defined as the weight of water divided by the weight of filamentous fungus on a dry matter basis may be at least 2, preferably at least 3. Ratio (B) may be less than 6, preferably less than 5, more preferably less than 4.5.

In said foodstuff, a ratio (C) defined as the weight of water divided by the weight of said agar may be at least 10, preferably at least 13. Ratio (C) may be less than 25 or less than 20.

Said foodstuff may include other ingredients. For example, said foodstuff may include a vegetable-based protein for example potato protein. Said foodstuff may include 0 to 3 wt %, preferably 0.5 to 3 wt %, more preferably 1 to 3 wt % of said vegetable-based protein, especially potato protein.

Said foodstuff may have a pH of less than 6 or less than 5. The pH may be at least 3, preferably at least 4. Preferably, the pH is in the range 4-5.

The foodstuff may include one or more ingredients added to adjust the pH of the foodstuff. Preferably, the foodstuff includes an acidulant. Said foodstuff may include at least 0.5 wt % of acidulant. It may include less than 2 wt % of acidulant.

The foodstuff may include one or more flavourants. In said foodstuff, the total amount of added flavourants may be at least 1 wt %, preferably at least 2 wt %. The total amount may be less than 4 wt %.

Said foodstuff may include a preservative at a level of less than 0.25 wt %. It may include at least 0.05 wt % of said preservative which may be a sorbate.

Said foodstuff may include:
17 to 22 wt % of filamentous fungus on a dry matter basis;
1 to 5 wt % (preferably 3 to 4 wt %) of agar;
0 to 3 wt % (preferably 1 to 2.5 wt %) of vegetable-based protein, for example potato protein;
1 to 4 wt % (preferably 1 to 3.5 wt %) in total of one or more flavourants;
0.5 to 2 wt % of acidulant;
0 to 0.2 wt % of preservative; and
63.8 to 80.5 wt % (preferably 65.8 to 78.5 wt % water.

Said foodstuff preferably includes less than 5 wt %, preferably 0 wt %, of egg albumin.

Said foodstuff preferably includes less than 5 wt %, preferably 0 wt %, of ingredients of animal origin.

Said foodstuff is preferably suitable for vegans. It preferably includes 0 wt % of components derived from animals.

Said foodstuff is preferably a meat-substitute, which suitably includes no meat.

Said foodstuff preferably comprises a sliced product. Said foodstuff preferably comprises a multiplicity of slices. The slices preferably have substantially identical compositions. The slices preferably have substantially identical thicknesses which may be less than 2 mm, preferably less than 1 mm; and may be at least 0.1 mm. The slices preferably have a substantially identical cross-sectional shape. The slices preferably have a substantially identical cross-sectioned shape and size.

Said foodstuff is preferably provided in a package. For example at least 2 slices (and suitably less than 25 slices) may be provided in said package. The package may be arranged to restrict passage of oxygen to the foodstuff therein. Said package may comprise a plastics packaging material.

Said foodstuff is preferably the only foodstuff contained in the package.

According to a second aspect of the invention, there is provided a process for making a foodstuff, the process comprising:

(i) selecting particles of filamentous fungus;

(ii) selecting agar;

(iii) contacting said particle of filamentous fungus with said agar.

Said foodstuff may have any feature of the foodstuff of the first aspect. Said filamentous fungus may have any feature of the foodstuff of the first aspect. Said agar may have any feature of the foodstuff of the first aspect.

In step (i) a biomass comprising filamentous fungus is suitably selected. Said biomass may be in the form of a paste. Said biomass may include 20-30 wt %, (preferably 22-26 wt %) of filamentous fungus on a dry matter basis and 70-80 wt %, (preferably 74 to 78 wt %) of water.

Said agar is suitably in a powder form.

The process may comprise selecting 30 to 95 wt %, preferably 70 to 90 wt %, more preferably 75 to 85 wt % of said biomass and contacting it with 1 to 5 wt % of said agar.

Other ingredients (e.g. additional water, flavourants, preservatives, acidulant and/or vegetable protein) may also be contacted with filamentous fungus in step (iii) or subsequent thereto.

In step (iii), a ratio (D) defined as the wt % of said biomass divided by the wt % of said agar contacted in step (iii) may be in the range 6-95, preferably in the range 14 to 90, more preferably in the range 15 to 40, especially in the range 17 to 27.

In step (iii), said particles of filamentous fungus and said agar are preferably mixed, optionally in the presence of other ingredients, preferably to produce a substantially homogenous mass.

After step (iii), a mixture comprising said filamentous fungus and agar (e.g. said substantially homogenous mass described) is preferably introduced into a receptacle or mould, suitably to form said mixture (e.g. said homogenous mass) into a predetermined shape. The receptacle is preferably elongate and suitably has a substantially contact cross-section along its extent, eg along at least 80% of its length. Said receptacle may be tubular. It may comprise a tubular casing.

After step (iii), suitably with said mixture (e.g. homogenous mass) in said receptacle (e.g. casing), said mixture is preferably subjected to an elevated temperature (e.g. greater than 50° C. and preferably in the range 70-100° C.), for example to cook the mixture. In the process, said mixture may be subjected to said temperature for at least 10 minutes and preferably less than 120 minutes. More preferably, it is subjected to said temperature for 15 to 60 minutes.

After step (iii) and preferably after said mixture has been subjected to said elevated temperature as described, said mixture is subjected to a reduced temperature of less than 0° C., preferably less than −4° C., more preferably less than −15°. It may be subjected to a temperature in the range −4° C. to −25° C., for example in the range −15° C. to −25° C. As a result, said mixture may be frozen.

In the process, said mixture is preferably subjected to said reduced temperature for at least 24 hours, preferably at least 96 hours. Subsequently, the temperature of said mixture is raised, for example to 0 to 10° C.

After being subjected to said reduced temperature and suitably after said temperature has been raised, for example to 0 to 10° C., said mixture may be fragmented, for example sliced, suitably to define a multiplicity of substantially identical slices. Prior to fragmentation (e.g. slicing), said mixture is suitably removed from said receptacle.

After fragmentation (e.g. slicing) said mixture (which suitably has any feature of the foodstuff of the first aspect) is preferably packaged. After packaging, it may be refrigerated (e.g. held at a temperature in the range 0 to 5° C.).

The product of the process of the second aspect is novel. Thus, in a third aspect, the invention extends to a product of the process of the second aspect per se.

Any feature of any aspect of any invention described herein may be combined with any feature of any other invention described herein mutatis mutandis.

Specific embodiments of the invention will now be described, by way of example, with reference to the accompanying figures, in which:

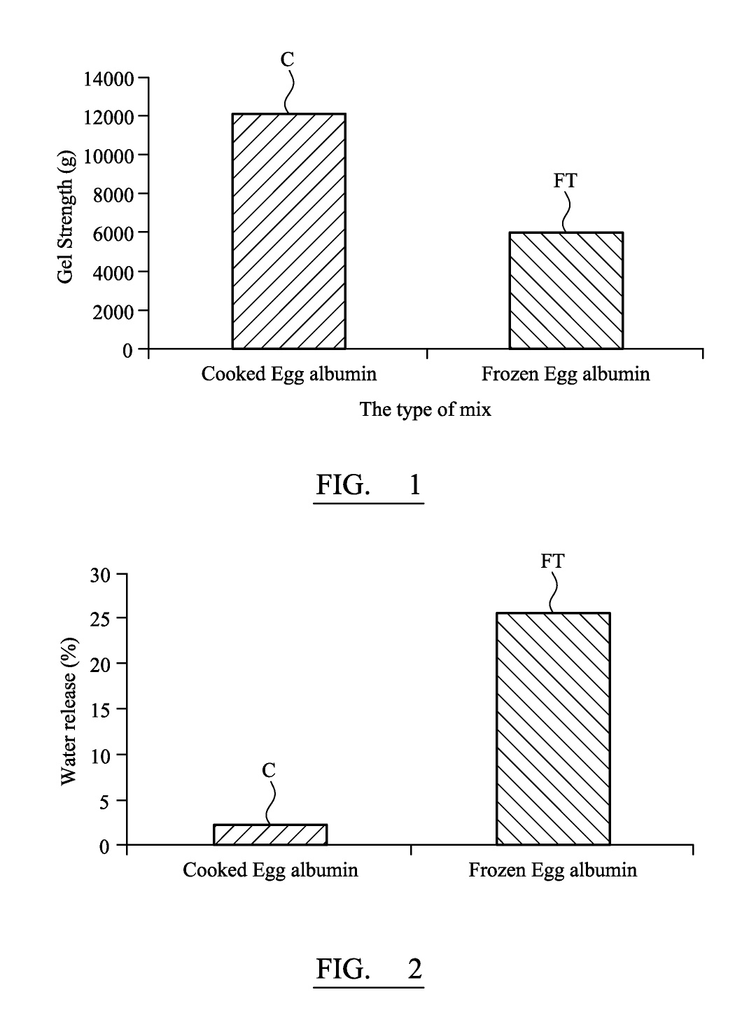

FIG. 1 is a graph comparing gel strengths of cooked and frozen egg albumin;

FIG. 2 is a graph comparing water release of cooked and frozen egg albumin;

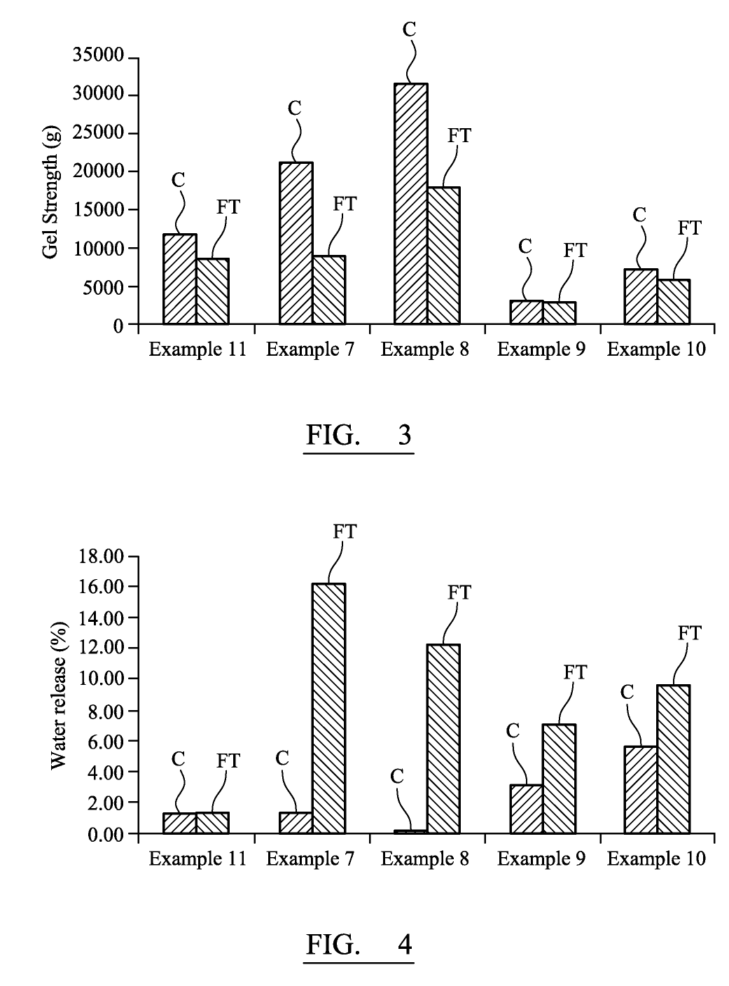

FIG. 3 is a graph comparing gel strengths of a range of other cooked or frozen samples;

FIG. 4 is a graph comparing water release of the samples shown in FIG. 3;

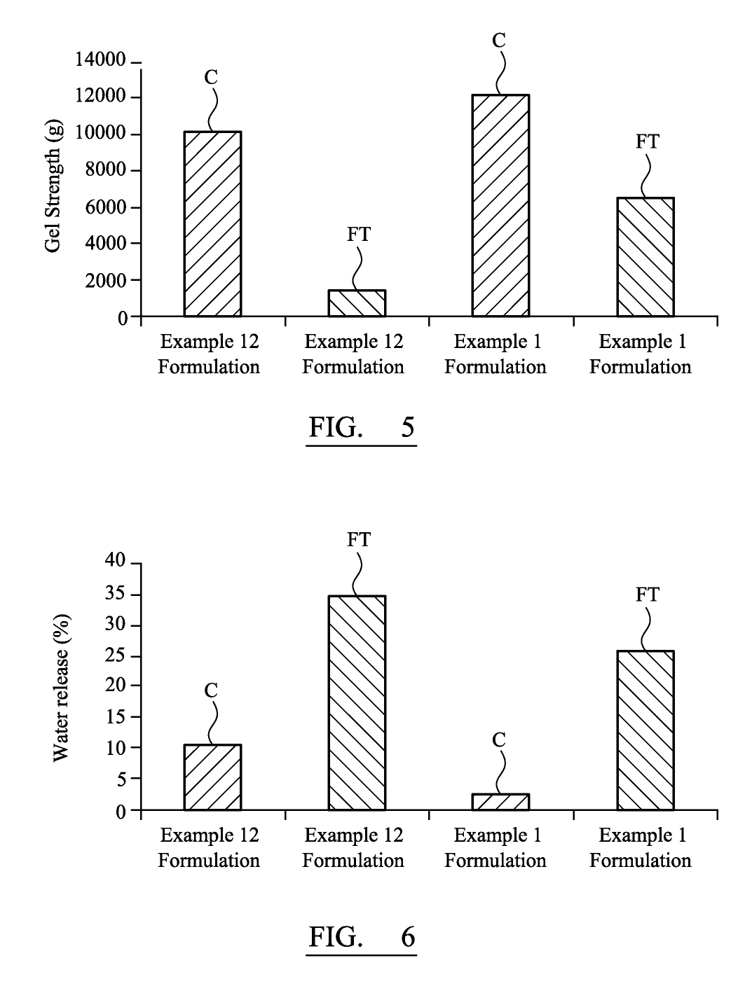

FIG. 5 is a graph comparing gel strengths of specified samples;

FIG. 6 is a graph comparing water release of specified samples;

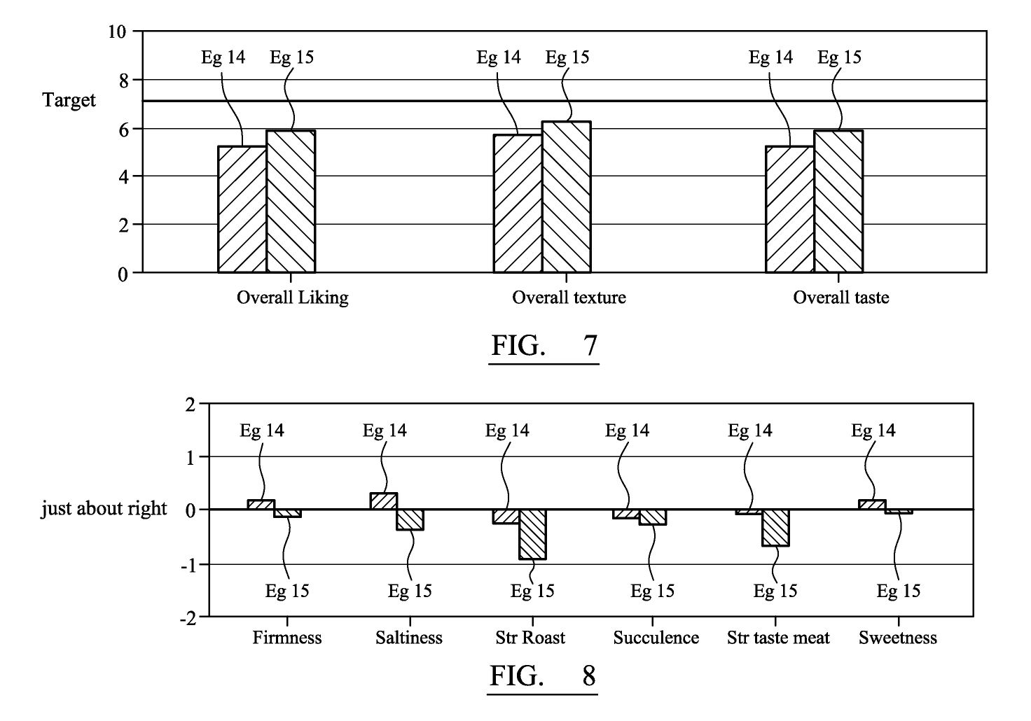

FIG. 7 is a graph comparing overall liking of a commercially available QUORN (Trademark) product and an agar-based product; and

FIG. 8 is a graph comparing a series of specific attributes of a commercially available QUORN (Trademark) product and an agar-based product.

The following material is referred to hereinafter:

Mycoprotein paste-Mycoprotein paste-refers to a visco-elastic material comprising a mass of edible filamentous fungus derived from Fusarium venenatum A3/5 (formerly classified as Fusarium graminearum Schwabe) (IMI 145425; ATCC PTA-2684 deposited with the American type Culture Collection, 12301 Parklawn Drive, Rockville Md. 20852) and treated to reduce its RNA content to less than 2% by weight by heat treatment. Further details on the material are provided in WO96/21362 and WO95/23843. The material may be obtained from Marlow Foods Limited of Stokesley, U.K. It comprises about 23-25 wt % solids (the balance being water) made up of non-viable RNA reduced fungal hyphae of approximately 400-750 μm length, 3-5 μm in diameter and a branching frequency of 2-3 tips per hyphal length.

Agar—commercially—available powdered agar for food applications having a gel strength (1.5 wt % solution at 20° C.) of approximately 1000 g/cm².

The following assessments are referred to hereinafter:

### Assessment 1—Textural Measurement Procedure on Products.

A compression test was undertaken on an edible formulated product using a Texture Analyser with a 5 kg load cell using a parallel plate 2 mm set to penetrate the material up to 0.5 cm at a speed of 1 mm/s. Data was collated during the test.

Assessment 2—Expressible Water Release from Samples Under Applied Force

The Texture Analyser described in Assessment 1 was used with a 5 kg load and a 20 mm parallel plate to express water from gel samples to enable water release to be assessed.

The water release percentages of samples was calculated by the equation

$$\frac{{W}_{o} - W}{{W}_{o}} \times 100$$

where Wo and W are the respective weights of samples before and after compression by the load cell of the Texture Analyser.

### Assessment 3—Gel Strength of Samples

A two-cycle uniaxial compression process was performed using the Texture Analyser described with a 25 kg load cell. The load cell was calibrated each time with a 5 kg weight. The equipment was set to zero automatically by lowering the plate until the bottom surface of the plate just contacted the table. Cylindrical sections (17 mm diameter) from the gel were cut into pieces 25 mm high using an adapted cheese cutter and were compressed between the stationary bottom platform and a moving upper plate of the texture analyzer. Data relevant to gel strength was collated.

Examples 1 to 6 which follow describe preparation of egg albumin-based formulations and investigations undertaken on such formulations to determine their properties.

### Example 1—Preparation of Egg Albumin-Gel Systems

16 wt % solutions of egg albumin were prepared using deionised water. Egg albumin powder was mixed with water and any other ingredients using a high shear kitchen blender until all powders were dissolved. The pH of the solutions was then adjusted to pH=6, using either concentrated NaOH or sulphuric acid. The solutions were poured into 17 mm diameter cellulose casings that were then tied up at both ends. Gelation of the egg albumin was induced by heating the casings at 100° C. in a steam oven for 20 minutes. After steaming, the samples were cooled down in a chiller to 5° C. and held overnight at this temperature before any textural measurement.

### Examples 2 and 3—Preparation of Other Egg Albumin-Gel Systems

The general procedure of Example 1 was used to produce egg albumin-based formulations containing 20 wt % egg albumin and 24 wt % egg albumin.

### Example 4—General Procedure for Freezing and Frozen Storage Procedure for Gel Systems

Selected samples were frozen in a blast freezer at a temperature of −21° C. for 3-4 hours.

Thereafter frozen samples were transferred to a cold store at −21° C. and held there for at least a week before any subsequent assessment.

### Example 5—General Procedure for Thawing Samples of Gel Systems

Prior to any assessment, frozen samples produced as described in Example 4 were thawed in a commercial steamer at 30° C. for 2 hours to ensure fully defrosted.

As described herein, egg albumin is included in commercially available QUORN (Trade Mark) products as a binder. In the preparation of such products, egg albumin powder is mixed with mycoprotein and other ingredients and is subsequently heat steamed to gel the egg albumin. This transforms the material from a pasty consistency to a material which is cuttable after chilling. At this stage, however, it is found the material releases very little water once compressed as per Assessment 3, which demonstrates that the egg albumin holds the water tightly in the mix. However, after freezing and subsequent thawing in the manner described in Examples 4 and 5, it is found that the water held in QUORN (Trade Mark) products by the egg albumin is separated and exuded to produce a meaty and succulent product. This effect was investigated further as described in Example 6.

### Example 6—Investigation of Properties of Egg Albumin Formulations

To investigate the properties of the QUORN (Trade Mark) products and, more particularly, the functioning of the egg albumin contained therein, the egg albumin-based formulation of Example 1 was investigated using Assessments 2 and 3 described. The formulation was assessed after chilling as described in Example 1 and after freezing and thawing as described in Examples 4 and 5.

FIG. 1 compares the gel strengths assessed for the cooked non-frozen product (labelled C) and for the cooked, frozen and thawed product (labelled FT). The figure illustrates how the frozen and thawed product has a significantly lower gel strength compared to the cooked non-frozen product.

FIG. 2 compares the water release properties of the cooked non-frozen product (labelled C) and the frozen and thawed product (labelled FT) from which it is clear that, for the cooked non-frozen product, water release is very low (less than 5 wt %) but, for the frozen and thawed product, its water release is high (25 wt % or more) meaning the product is spongy.

Thus, it is clear from the above that freezing and thawing of egg albumin-based formulations leads to production of products which appear to be meaty and succulent when chewed.

Other proteins were investigated and compared to egg albumin to assess whether the effects observed for egg albumin are common amongst proteins and to establish desirable characteristics for materials which may be used to produce a meaty, succulent texture. Examples 7 to 11 describe the investigations undertaken.

### Examples 7 to 11—Investigation of Other Protein-Based Formulations

In a manner analogous to Example 6, other concentrations of egg albumin and other proteins were investigated. Details on the examples are provided in Table 1 below.

TABLE 1

| | | Concentration |
|---|---|---|
| | | of protein in |
| Example | Protein used | water |
| 7 | Egg albumin | 20 wt % |
| 8 | Egg albumin | 24 wt % |
| 9 | Potato protein | 24 wt % |
| 10 | Whey protein | 24 wt % |
| 11 | Egg albumin, potato protein and | 8 wt % of each |
| | whey protein blend | component |

Results of assessments are provided in FIGS. 3 and 4 which show that not all proteins function in the manner described in FIGS. 1 and 2 for egg albumin. A review of the results in FIG. 3 for potato protein and whey protein (Examples 9 and 10 respectively) show the difference in gel strength between cooked non-frozen products (labelled C) and cooked, frozen and thawed products (labelled FT) is relatively small in comparison to the difference for the egg albumin formulations (Examples 7 and 8). For Example 11 (which includes 8 wt % egg albumin) the difference in gel strength between cooked non-frozen (labelled C) and cooked, frozen and thawed (labelled FT) samples is greater than for Examples 9 and 10 but significantly less than for the egg albumin examples 7 and 8 which exhibit a large difference in gel strength between cooked non-frozen and cooked, frozen/thawed samples. The gel strength of the more concentrated egg albumin formulation (Example 8) is higher than for the lower concentration formulation (Example 7).

FIG. 4 shows the Example 7 formulation has the highest water release with the Example 8 formulation next highest. The formulations of Examples 9 to 11 release significantly less water meaning such formulations have the least sponginess.

The inventors have appreciated from the aforementioned investigations (and other investigations) that the following characteristics are desirable in a gellable material to enable it to be advantageously used in a food product (e.g. a vegan and/or non-egg albumin-based food product) which has a meaty, succulent texture:

(i) a reasonably high gel strength (measured as described in Assessment 3) after cooking and freezing/thawing.

(ii) a reasonable level of water release after cooking and freezing/thawing (measured as described in Assessment 2).

(iii) edible at the level used.

(iv) able to be mixed with mycoprotein fibres.

One gellable material the inventors have unexpectedly found generally to satisfy the desired characteristics is the polysaccharide, agar. The following examples describe investigations involving agar and comparisons with egg albumin.

### Example 12—General Procedure for Preparation of Agar-Based Gel System

6 wt % solutions of agar were prepared using deionised water. In this regard, agar powder was mixed with water using a high shear kitchen blender until all the powder had dissolved. The pH of the solution was then adjusted to pH 6 using either concentrated NaOH or sulphuric acid. The solution was then poured into a 17 mm diameter cellulose casing that was then tied up at both ends. The agar was dissolved and hydrated well by heating the casing at 100° C. in a steam oven for 20 minutes. After steaming, the casing was cooled down in a chiller to 5° C. and held overnight at this temperature before any textural measurement.

### Example 13—Investigation of Properties of Agar-Based Gel System and Comparison with Egg Albumin-Based Gel System

The agar based formulation of Example 12 and the 16 wt % egg albumin-based formulation of Example 1 were investigated and compared using Assessments 2 and 3. The formulations were assessed after chilling and after freezing/thawing as described in Examples 4 and 5.

FIG. 5 compares the gel strengths assessed for cooked, non-frozen (labelled C) and cooked and frozen/thawed (labelled FT) Example 12 and Example 1 formulations from which it will be noted that, in both cases, the gel strengths decrease significantly after freezing/thawing.

FIG. 6 compares the water release for the cooked non-frozen and cooked and frozen/thawed Example 12 and Example 1 formulations from which it is clear that, in both cases, the water release by the gels increases substantially after freezing.

To show that edible meat-free formulations containing agar can be made and have suitable properties, egg albumin-based and agar-based formulations were made following the general procedures in Examples 14 and 15.

### Example 14—Preparation of Egg Albumin-Based Sliced, Cold, Meat-Free (but Meat-Like), Chicken-Flavoured Product

Mycoprotein paste was weighed into a mixing bowl of a food mixer and water was added, prior to mixing for about 1 minute. Then, all the dry ingredients to be included, namely chicken flavour, egg albumin and acidulant were added and mixed for a few minutes. Periodically, mixing was stopped to redistribute materials that were stood away from the impeller. Mixing was continued in order to achieve an even distribution of all ingredients within the mix. Once achieved, mixing was stopped and the material was filled into chub sausage casings using a manual sausage filler. Chubs were then transferred into a steamer and cooked at 100° C. for about 25 minutes to set the egg albumin. After steaming, the cooked chub was transferred to a blast freezer and left to freeze for around 120 minutes. The frozen chub was then located inside a marked sample bag, transferred into a cold store and held there at −21° C. for around a week before defrosting for evaluation.

The aforementioned method is currently used to prepare a commercially-available QUORN (Trade Mark) chicken-flavoured delicatessen (meat-free) product.

### Example 15—Preparation of Agar-Based, Sliced, Cold, Meat-Free (but Meat-Like), Vegan, Chicken Flavoured Product

Following the procedure described in Example 14, an agar-based product was made as a vegan version of the commercially available product of Example 14. A summary of the recipe is provided in the table below.

| Ingredient | Wt % |
|---|---|
| Mycoprotein paste | 80.9 |
| Water | 10.0 |
| Meat-free chicken flavour | 2.8 |
| Potassium sorbate | 0.2 |
| Acidulant | 1.1 |
| Agar powder | 3.6 |
| Potato protein | 1.4 |

### Example 16—Assessment of Products of Examples 14 and 15

Sensory evaluation of the products of Examples 14 and 15 was undertaken using a consumer panel, comprising 9 meat-eaters and 9 vegetarians, all of which were regular consumers of QUORN (Trade Mark) products.

Defrosted samples of products, were sliced and generously filled into sandwiches and served in a balanced order. Results are provided in FIGS. 7 and 8.

Referring to FIG. 7, the overall liking, texture and taste of the Example 15 (agar-based) product was generally better than the Example 14 (egg-based) product.

Referring to FIG. 8, the firmness, saltiness, strength of roast taste, succulence, strength of meaty/savoury taste and the sweetness of the Example 15 (agar-based) and Example 14 (egg-based) were comparable and in each case the characteristics of the agar-based product assessed was acceptable.

Thus, the inventors have shown that agar can be used to make a sliced, cold, meat-free (but meat-like) product, suitable for vegans, which is comparable in taste (and other properties) to commercially available QUORN (Trade Mark) products.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1-34. (canceled)

35. A foodstuff comprising particles of a filamentous fungus and agar.

36. A foodstuff according to claim 35, wherein said foodstuff includes less than 5 wt % of agar and includes at least 0.5 wt % of agar.

37. A foodstuff according to claim 35, wherein said foodstuff includes 3 to 4 wt % of agar.

38. A foodstuff according to claim 35, which includes at least 7 wt % and less than 25 wt % of said filamentous fungus on a dry matter basis.

39. A foodstuff according to claim 35, wherein a ratio (A) defined as the weight of filamentous fungus on a dry matter basis divided by the weight of agar is at least 1 and is less than 25.

40. A foodstuff according to claim 35, wherein:
said foodstuff includes 15 to 21 wt % of said filamentous fungus on a dry matter basis;
a ratio (A) defined as the weight of filamentous fungus on a dry matter basis divided by the weight of agar is in the range 4 to 7; and
the total amount of water in said foodstuff is in the range 60 to 80 wt %.

41. A foodstuff according to claim 35, wherein the total amount of water in said foodstuff is at least 25 wt % and is less than 81 wt %.

42. A foodstuff according to claim 35 which includes:
7 to 25 wt % of said filamentous fungus on a dry matter basis;
1 to 5 wt % of agar; and
30 to 85 wt % of water.

43. A foodstuff according to claim 35 which includes:
15 to 24 wt % of said filamentous fungus on a dry matter basis;
2 to 5 wt % of agar; and
60 to 80 wt % of water.

44. A foodstuff according to claim 35, wherein a ratio (B) defined as the weight of water divided by the weight of filamentous fungus on a dry matter basis is at least 2 and is less than 6; and a ratio (C) defined as the weight of water divided by the weight of said agar is at least 10 and is less than 25.

45. A foodstuff according to claim 35 which includes 1 to 3 wt % of potato protein.

46. A foodstuff according to claim 35 which has a pH of less than 6 and has a pH of at least 3.

47. A foodstuff according to claim 35, which includes:
17 to 22 wt % of filamentous fungus on a dry matter basis;
1 to 5 wt % of agar;
0 to 3 wt % of vegetable-based protein;
1 to 4 wt % in total of one or more flavourants;
0.5 to 2 wt % of acidulant;
0 to 0.2 wt % of preservative; and
63.8 to 80.5 wt % water.

48. A foodstuff according to claim 35, which includes 0 wt % of ingredients of animal origin.

49. A foodstuff according to claim 35, wherein a multiplicity of slices of said foodstuff are provided, said slices being provided in a package, wherein the package is arranged to restrict passage of oxygen to the foodstuff therein

50. A process for making a foodstuff according to claim 35, the process comprising:
selecting particles of filamentous fungus;
(ii) selecting agar; and
(iii) contacting said particles of filamentous fungus with said agar.

51. A process according to claim 50, wherein:
in step (i) a biomass comprising filamentous fungus is selected, wherein said biomass includes 20 to 30 wt % of filamentous fungus on a dry matter basis;
30 to 95 wt % of said biomass is selected and contacted with 1 to 5 wt % of said agar; and
after step (iii), a mixture comprising said filamentous fungus and agar is introduced into a receptacle or mould.

52. A process according to claim 51, wherein:
after step (iii), said mixture is subjected to an elevated temperature to cook the mixture;
after being subjected to an elevated temperature, said mixture is subjected to a reduced temperature of less than 0° C.; and
after being subjected to said reduced temperature, said mixture is fragmented to define a multiplicity of slices.

53. A foodstuff comprising particles of a filamentous fungus and agar, wherein:
said foodstuff includes less than 5 wt % of agar and includes at least 0.5 wt % of agar;
said foodstuff includes at least 7 wt % and less than 25 wt % of said filamentous fungus on a dry matter basis;
a ratio (A) defined as the weight of filamentous fungus on a dry matter basis divided by the weight of agar is at least 1 and is less than 25; and
the total amount of water in said foodstuff is at least 25 wt % and is less than 81 wt %.

54. A foodstuff according to claim 53, wherein a multiplicity of slices of said foodstuff are provided, said slices being provided in a package, wherein the package is arranged to restrict passage of oxygen to the foodstuff therein.
